(19) United States
(12) Patent Application Publication
(10) Pub. No.: US 2023/0394298 A1
(43) Pub. Date: Dec. 7, 2023

(54) WATERMARKING DEEP GENERATIVE MODELS

(71) Applicant: International Business Machines Corporation, Armonk, NY (US)

(72) Inventors: Ambrish Rawat, Dublin (IE); Killian Levacher, Dublin (IE); Beat Buesser, Ashtown (IE); Rahul Nair, Dublin (IE)

(21) Appl. No.: 17/831,541

(22) Filed: Jun. 3, 2022

(51) Int. Cl. G06N 3/08

(52) U.S. Cl. CPC G06N 3/08

(57) ABSTRACT

A system may include a memory and a processor in communication with the memory. The processor may be configured to perform operations. The operations may include procuring a model and obtaining hyperparameters for watermarking the model. The operations may include embedding a watermark in the model using the hyperparameters to achieve a watermarked model and delivering the watermarked model and a watermark verification mechanism to a user.

### BACKGROUND

The present disclosure relates to artificial content generation, and more specifically to generative models and neural networks.

Various techniques may be used to generate artificial content. Artificial content may include, for example, images, audio, video, and/or text. High-dimensional data manifolds may be used to generate artificial content. Artificial content may be generated using neural networks and/or generative models.

### SUMMARY

Embodiments of the present disclosure include a system, method, and computer program product for watermarking a model.

A system in accordance with the present disclosure may include a memory and a processor in communication with the memory. The processor may be configured to perform operations. The operations may include procuring a model and obtaining hyperparameters for watermarking the model. The operations may include embedding a watermark in the model using the hyperparameters to achieve a watermarked model and delivering the watermarked model and a watermark verification mechanism to a user.

The above summary is not intended to describe each illustrated embodiment or every implementation of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a model watermarking system in accordance with some embodiments of the present disclosure.

FIG. 2 illustrates a model with a verification system in accordance with some embodiments of the present disclosure.

FIG. 3 depicts a model with a verification system in accordance with some embodiments of the present disclosure.

FIG. 4 illustrates a model with a verification system in accordance with some embodiments of the present disclosure.

FIG. 5 depicts a method of watermarking a model in accordance with some embodiments of the present disclosure.

FIG. 6 illustrates a method of watermarking a model in accordance with some embodiments of the present disclosure.

FIG. 7 depicts a cloud computing environment in accordance with embodiments of the present disclosure.

FIG. 8 illustrates abstraction model layers in accordance with embodiments of the present disclosure.

FIG. 9 depicts a high-level block diagram of an example computer system that may be used in implementing one or more of the methods, tools, and modules, and any related functions, described herein, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to artificial content generation, and more specifically to generative models and neural networks.

Various techniques may be used to generate artificial content. Artificial content may include, for example, synthetic images, audio, video, and/or text. High-dimensional data manifolds may be used to generate artificial content. Artificial content may be generated using a neural network (NN), a generative model (GM), and/or a deep generative model (DGM).

A DGM is a large-scale model that may use one or more artificial intelligence (AI) techniques. An example of a DGM is a generative adversarial network (GAN). A DGM may be used for producing artificial content such as synthetic samples from high-dimensional manifolds. Examples of high-dimensional manifolds include, for example, text, images, audio, video, molecules, and/or complex relational data.

Training a model (e.g., a DGM) may be resource intensive. Some models may be outsourced such that one entity builds a model and another entity uses the model; the entity that owns the model may be interested in protecting the intellectual property of the model. In some embodiments, the present disclosure may offer a mechanism for watermarking a model so as to protect the intellectual property of the model.

DGMs may differ from traditional discriminator models regarding definitions of input and output; for example, DGMs may be used to produce high-dimensional data from low-dimensional inputs. In some embodiments of the present disclosure, the architecture of DGMs may be leveraged to verify a DGM using a backdoor mechanism; in some embodiments, the DGM may be verified by checking one or more specific input-output combinations. Such backdoor verification may protect intellectual property (e.g., model architecture) of models that support black-box mode verification. Such backdoor verification of a model may be completed using only access to the application programming interface (API) of a service.

Some embodiments of the present disclosure focus on watermarking of generative tasks, generative models, and DGMs. In some embodiments, the present disclosure may be used to protect a specific instance of a DGM model architecture and/or model weights. Some embodiments of the present disclosure may protect intellectual property by enabling a user to identify the author of a particular model using only API access to the model.

In some embodiments of the present disclosure, a watermark may be inserted into a pre-trained model. In some embodiments, a watermark may be inserted into a model without modifying the training dataset of the model. In some embodiments, the present disclosure may be used to watermark a model that has already been trained such that the model need not be resubmitted to training for its originally intended purpose.

Some embodiments of the present disclosure may add one or more watermarks to a model without relying on the original dataset used to train the model (e.g., the training dataset). For example, a DGM may be rigorously trained with an original dataset, tested, and prepared for deployment, and the present disclosure may be used to watermark the DGM such that it need not be retrained with the original dataset. In some embodiments, a DGM may be trained using proprietary data, prepared for deployment, and/or deployed, and the DGM may be thereinafter watermarked without the need for review or reuse of the proprietary training data.

In accordance with the present disclosure, the samples provided by the model may be optimized while providing a mechanism for verifying the authenticity of the model. For example, some watermarking mechanisms may modify products (e.g., synthetic samples) by embedding a digital stamp on each of the products to identify that the products were generated using a particular model from a particular owner; in some embodiments, the present disclosure enables verification of a model without the need to embed a digital stamp on each model product.

A system in accordance with the present disclosure may include a memory and a processor in communication with the memory. The processor may be configured to perform operations. The operations may include procuring a model and obtaining hyperparameters for watermarking the model. The operations may include embedding a watermark in the model using the hyperparameters to achieve a watermarked model and delivering the watermarked model and a watermark verification mechanism to a user.

In some embodiments of the present disclosure, the model may be a deep generative model.

In some embodiments of the present disclosure, the hyperparameters may include target metrics for model utility and watermark fidelity. In some embodiments of the present disclosure, the hyperparameters include a computational budget.

In some embodiments of the present disclosure, the operations may include selecting a mechanism for embedding the watermark based on the model and the hyperparameters.

In some embodiments of the present disclosure, embedding the watermark may include training the model using an architecture specification, a training routine, and training data. In some embodiments of the present disclosure, the model may be pre-trained, and embedding the watermark may include modifying the model to embed the watermark.

In some embodiments of the present disclosure, the operations may include computing a set of metrics to assess the watermarked model for model utility and watermark fidelity.

In some embodiments of the present disclosure, the operations may include receiving the watermark. In some embodiments of the present disclosure, the operations may include selecting the watermark. In some embodiments of the present disclosure, the operations may include developing the watermark.

In some embodiments of the present disclosure, the watermark verification mechanism may include a trigger-target pair representing the watermark.

In some embodiments of the present disclosure, the watermark may include a trigger-target pair for the model.

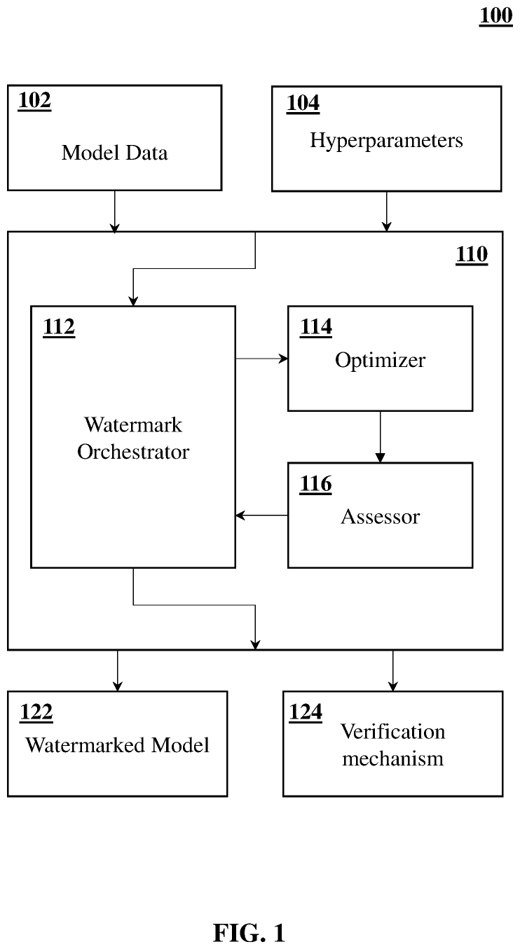

FIG. 1 illustrates a model watermarking system 100 in accordance with some embodiments of the present disclosure. The system 100 includes two inputs, a watermarking component 110, and two outputs.

The system 100 inputs include model data 102 and hyperparameters 104. The model data 102 may include, for example, a pre-trained model to be watermarked and/or training details for the model to be watermarked; training details may include, for example, an architecture specification, a training routine, training data, and the like. In some embodiments, the model to be watermarked may be a DGM (e.g., a GAN); in some embodiments, the model data 102 may include the details necessary for training a DGM.

The system 100 inputs include hyperparameters 104. The hyperparameters 104 may control target metrics such as acceptable tradeoffs which may occur (e.g., between model utility and watermark fidelity). In some embodiments of the present disclosure, the watermark may be included as an input into the model watermarking system 100; in such an embodiment, the hyperparameters 104 may include a trigger-target that defines the watermark. In some embodiments of the present disclosure, a watermark may be selected and/or generated by the model watermarking system 100; in such an embodiment, the hyperparameters 104 may include data and/or metrics for selecting and/or generating the watermark.

The watermarking component 110 includes a watermark orchestrator 112, an optimizer 114, and an assessor 116. The watermark orchestrator 112 receives the inputs and orchestrates the watermarking process. The watermark orchestrator 112 selects the most suitable mechanism for watermarking based on the model data 102 and the hyperparameters 104; in some embodiments, the watermark orchestrator 112 may select the most suitable method for backdooring the model to watermark it. The watermarking orchestrator 112 may select a watermarking mechanism based on the number of parameters in the model, the training data, the optimization budget, and the like.

The watermark orchestrator 112 may be defined via a set of rules. The rules may determine the most suitable mechanism for watermarking a model based on the model, model data 102, and/or training specification.

In some embodiments of the present disclosure, one or more trigger-target pairs defining one or more watermarks may be provided as an input. In some embodiments of the present disclosure, a trigger-target pair may not be provided; in such an embodiment, the watermark orchestrator 112 may generate a trigger-target pair by selecting a trigger sample that is out-of-distribution with respect to the input distribution of the model as the trigger, selecting a target sample that is out-of-distribution with respect to the output distribution as the target, and pairing the trigger with the target. In some embodiments, the watermark orchestrator 112 may select a trigger sample and/or target sample at random. In some embodiments, algorithm(s) may be used to select the sample trigger, sample target, and/or sample trigger-target pairs.

In some embodiments of the present disclosure, a model may be trained from scratch such that the watermark is embedded in the model during its original training series. In such an embodiment, the watermarking component 110 may select a training algorithm to train the model; in some embodiments, training with adversarial loss function (TrAIL) and/or backdoor attack against auto-encoders (BAAAN) may be selected. In some embodiments of the present disclosure, a backdoor may be implemented during training, for example, using TrAIL or BAAAN.

Hyperparameters 104 such as weights in a loss function, learning rate, and the like may be determined using auto-AI techniques and/or predefined for the specific model type(s). In some embodiments, the hyperparameters 104 may be selected and/or determined based on, for example, computation budget, architecture parameters, and/or the number of architecture parameters. In some embodiments of the present disclosure, the hyperparameters 104 may be determined by the watermark orchestrator 112 and submitted to the optimizer 114.

The watermarking component 110 includes an optimizer 114. The watermarking orchestrator 112 may communicate optimization details and/or instructions to the optimizer 114. Optimization details and instructions may include, for example, a trigger-target that defines a watermark, target metrics (e.g., a model utility target and/or a watermark fidelity target), data for selecting and/or generating a watermark, training details, and the like. Optimization details and instructions may include, for example, definitions for the loss functions for training with algorithms such as TrAIL, retraining with expansion (ReX), retraining with distillation (ReD), and/or BAAAN. Optimization details and instructions may include, for example, hyperparameters such as loss function weights, regularization terms, number of training iterations, and the like.

In some embodiments, the optimizer 114 may train the model to be watermarked. In such an embodiment, the optimizer 114 may receive training instructions from the watermark orchestrator 112 for conducting the model training; such instructions may include the definition of the loss function for the training algorithm(s) to be used (e.g., TrAIL, ReD, ReX, BAAAN, and/or the like) as well as the hyperparameters (e.g., loss function weights, regularization terms, number of training iterations, and the like). The optimizer 114 may execute training steps using any necessary or preferred algorithms. The algorithms the optimizer 114 execute training steps for may include, for example, TrAIL, ReX, ReD, and/or BAAAN.

The watermarking component 110 includes an assessor 116. The assessor 116 may compute metrics quantifying the model utility and watermark fidelity. The assessor 116 may compute the desired metrics of a model and/or the actual metrics of a model; in some embodiments of the present disclosure, such computations may enable a comparison of the actual model metrics with the desired model metrics.

The assessor 116 may compute metrics including model utility, watermark fidelity, and/or watermark robustness. Optimizing the model (e.g., with the optimizer 114) for a watermark (e.g., a backdoor watermark) may compromise model utility (e.g., performance) with respect to the original task intended for the model. In some embodiments, maintaining the utility of a model may be preferred; simultaneously or alternatively, ensuring a watermark has a high fidelity may be preferred. Other objectives may include, for example, watermark robustness such that simple manipulations of a model may or may not neutralize a watermark.

In some embodiments, the assessor 116 may engage in brute-force sampling to measure the metrics such as, for example, using brute-force to sample for measuring model utility and/or computing metrics such as inception score, Fréchet inception distance (FID) score, and the like. Similarly, the assessor 116 may measure watermark fidelity using the mean squared distance for some watermarks (e.g., singleton watermarks); in some embodiments, the assessor 116 may use other metrics (e.g., complex metrics and/or complex algorithms) to measure the watermark fidelity of some watermarks and/or when multiple watermarks are used in the model.

The assessor 116 may submit the optimized and assessed model to the watermark orchestrator 112. In some embodiments, the watermark orchestrator 112 may engage in additional iterations of optimization and assessment by submitting the model to the optimizer 114 for further optimization; such embodiments may include metric thresholds such that the watermark orchestrator 112 may compare the model metrics as assessed by the assessor 116 to the metric thresholds to identify whether the model is to be submitted for additional iterations of optimization and assessment.

The watermark orchestrator 112 may receive the watermarked model 122 and a report from the assessor 116. In some embodiments, metric thresholds for a model may be used; the watermark orchestrator 112 may re-submit the watermarked model 122 to the optimizer for further iterations, and, upon meeting or exceeding the metric thresholds, the watermark orchestrator 112 may exit the iterations loop. In some embodiments, only a single loop (e.g., one pass through the optimizer 114 and assessor 116) will be necessary and/or preferred; in some embodiments, two iterations may be preferred; in some embodiments, three or more iterative loops may be preferred.

The watermarking component 110 (e.g., via the watermark orchestrator 122) may identify that a watermarked model 122 is ready for deployment. In some embodiments, target metrics (e.g., meeting model utility, watermark fidelity, and/or watermark robustness thresholds) may be used to determine a watermarked model 122 is ready for deployment; in some embodiments, a target number of iterations (e.g., two passes through the optimizer 114 and the assessor 116) may be used to determine a watermarked model 122 is ready for deployment. In some embodiments, metrics (e.g., achieving all threshold targets) and iterations (e.g., minimum of two loops) may both be used to determine a watermark is prepared for deployment.

The watermarking component 110 may output a watermarked model 122 and a verification mechanism 124 to a user. The verification mechanism 124 may be, for example, the watermark trigger-target pair(s).

In some embodiments, a trigger-target defining a desired watermark may not be provided; in such embodiments, the watermarking component 110 may select a random, out-of-distribution sample with respect to the model input distribution as a trigger and an out-of-distribution sample with respect to the model output distribution as a target to render a watermark defined by the trigger-target pair.

In some embodiments, a model to be watermarked may be trained from scratch with the system 100. In such an embodiment, the watermark orchestrator 112 may select an algorithm such as TrAIL or BAAAN to train the model. Hyperparameters 104 for the model, such as weights in loss function or learning rate, may be determined using auto-AI techniques or may be predefined for specific model types depending on computation budget and architecture parameters. The watermark orchestrator 112 may train the model using information provided in the inputs (e.g., the model data 102) and submit the model to the optimizer 114.

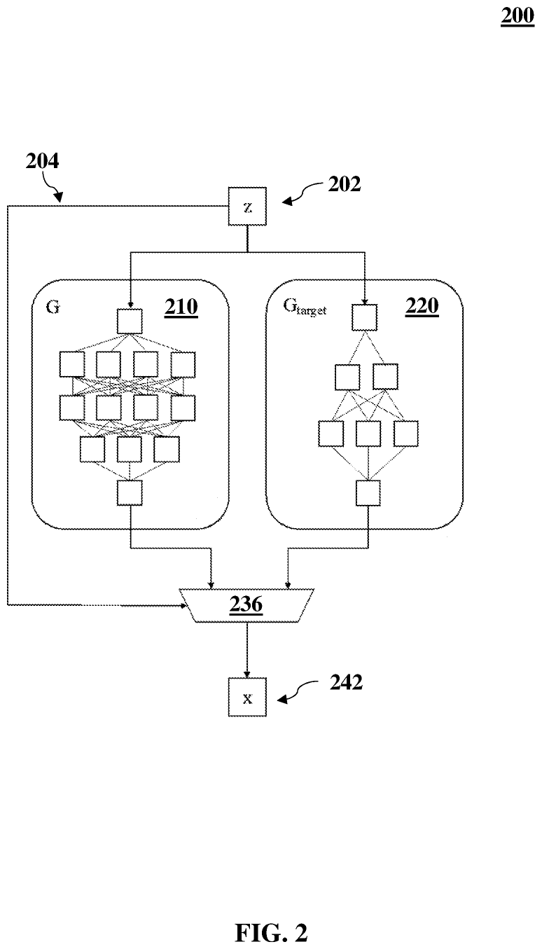

FIG. 2 depicts a model 200 with a verification system in accordance with some embodiments of the present disclosure. The model 200 may include, for example, a computation bypass system. The model 200 system includes an input 202, a bypass 204, a first network 210, a second network 220, a black box 236, and an output 242.

In some embodiments, the first network 210 may be a tool for achieving the original purpose of the model; for example, the first network 210 may be a classical operation model which returns one or more synthetic samples in response to an inquiry. In some embodiments, the second network 220 may be a security mechanism such as a model for driving a watermark.

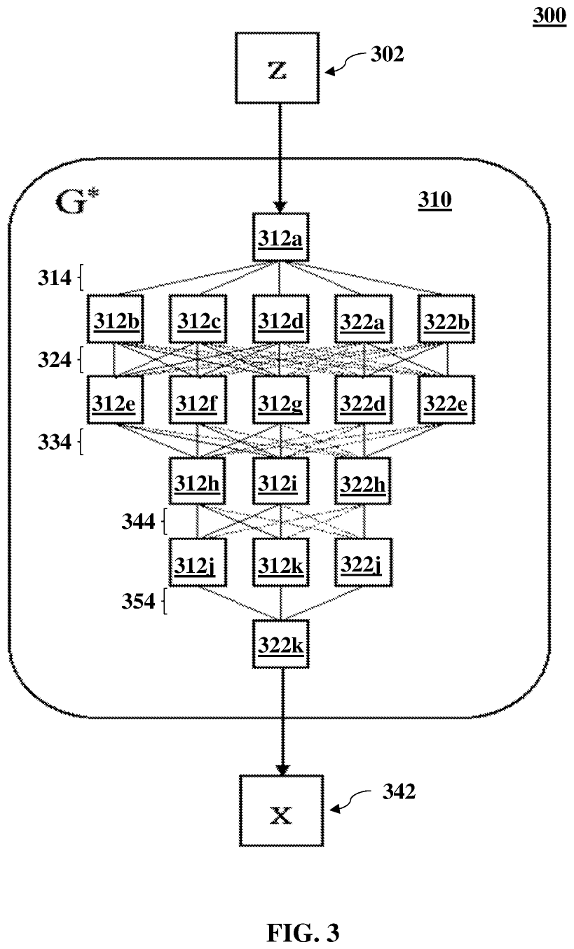

FIG. 3 illustrates a model 300 with a verification system in accordance with some embodiments of the present disclosure. The model 300 includes an input 302, a network 310, and an output 342.

In some embodiments of the present disclosure, the model 300 may be a classical operation model (e.g., first network 210 of FIG. 2) expanded with additional hidden units in one or more layers. In some embodiments, during training, the original weights may be kept fixed, cross-products among the original and/or expanded components may be set to zero, and only the weights of the expanded components may be updated; such an embodiment may be referred to as a ReX model.

The boxes within the network 310 signify nodes; nodes may also be referred to as features or aspects of a model. The nodes include original network units 312a-k and additional hidden units 322a-k. The lines 314, 324, 334, 344, and 354 within the network 310 may denote weights and/or parameters.

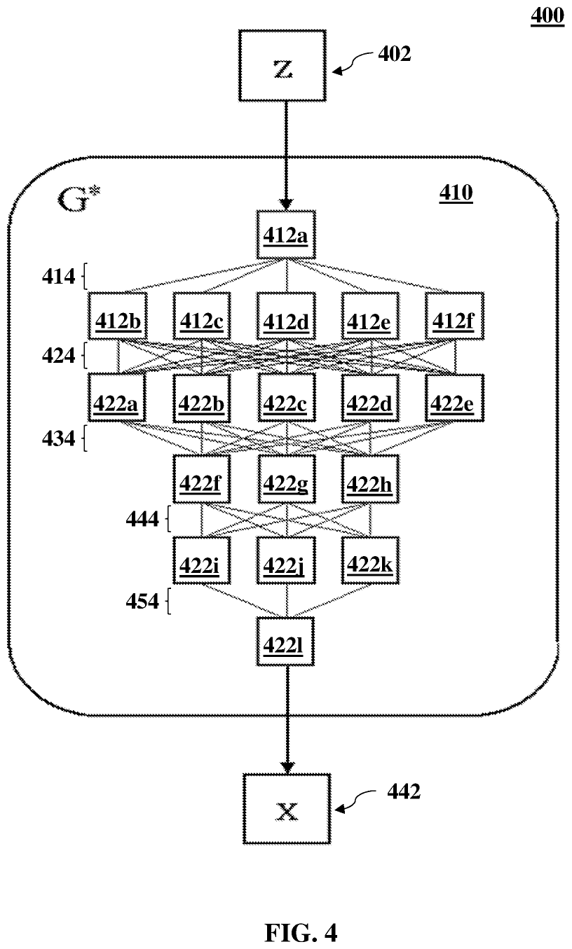

FIG. 4 depicts a model 400 with a verification system in accordance with some embodiments of the present disclosure. The model 400 includes an input 402, a network 410, and an output 442.

In some embodiments of the present disclosure, the model 400 may be a classical operation model (e.g., first network 210 of FIG. 2) expanded with additional hidden units in one or more layers. In some embodiments, during training, the original architecture may be kept fixed and a subset of the internal layers may be retrained; such an embodiment may be referred to as a ReD model.

The boxes within the network 410 signify nodes; nodes may also be referred to as features or aspects of a model. The nodes include original network units 412a-f and additional hidden units 422a-l. The lines 414, 424, 434, 444, and 454 within the network 410 may denote weights and/or parameters.

A method in accordance with the present disclosure may include procuring a model and obtaining hyperparameters for watermarking the model. The method may include embedding a watermark in the model using the hyperparameters to achieve a watermarked model and delivering the watermarked model and a watermark verification mechanism to a user.

In some embodiments of the present disclosure, the model may be a deep generative model.

In some embodiments of the present disclosure, the hyperparameters may include target metrics for model utility and watermark fidelity. In some embodiments of the present disclosure, the hyperparameters include a computational budget.

In some embodiments of the present disclosure, the method may include selecting a mechanism for embedding the watermark based on the model and the hyperparameters.

In some embodiments of the present disclosure, embedding the watermark may include training the model using an architecture specification, a training routine, and training data. In some embodiments of the present disclosure, the model may be pre-trained, and embedding the watermark may include modifying the model to embed the watermark.

In some embodiments of the present disclosure, the method may include computing a set of metrics to assess the watermarked model for model utility and watermark fidelity.

In some embodiments of the present disclosure, the method may include receiving the watermark. In some embodiments of the present disclosure, the method may include selecting the watermark. In some embodiments of the present disclosure, the method may include developing the watermark.

In some embodiments of the present disclosure, the watermark verification mechanism may include a trigger-target pair representing the watermark.

In some embodiments of the present disclosure, the watermark may include a trigger-target pair for the model.

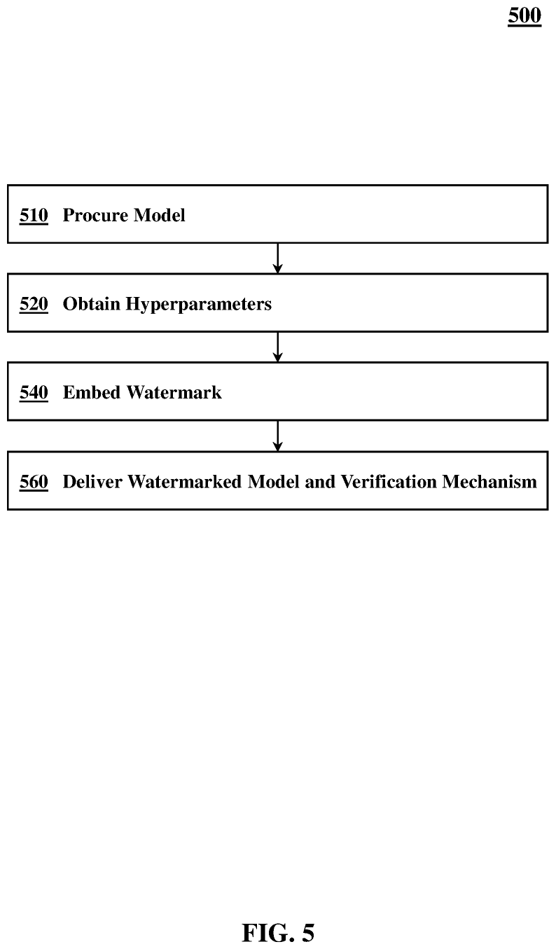

FIG. 5 depicts a method 500 of watermarking a model in accordance with some embodiments of the present disclosure. The method 500 includes procuring 510 a model, obtaining 520 hyperparameters, embedding 540 a watermark, and delivering 560 a watermarked model and verification mechanism to a user.

In some embodiments, the method 500 may be performed with a model watermarking system (e.g., model watermarking system 100 of FIG. 1). In some embodiments, the model procured may use a computation bypass mechanism (e.g., model 200 of FIG. 2), a ReX mechanism (e.g., model 300 of FIG. 3), and/or a ReD mechanism (e.g., model 400 of FIG. 4).

In some embodiments of the present disclosure, procuring 510 a model may be receiving a fully trained model; in some embodiments, procuring 510 a model may be receiving a partially trained model. In some embodiments, procuring 510 a model may be receiving model training information and constructing a model therewith (e.g., using the model watermarking system of FIG. 1). In some embodiments, procuring 510 the model and embedding 540 the watermark may occur simultaneously (e.g., if a model to be watermarked is trained by the model watermarking system, the training and watermarking may happen together).

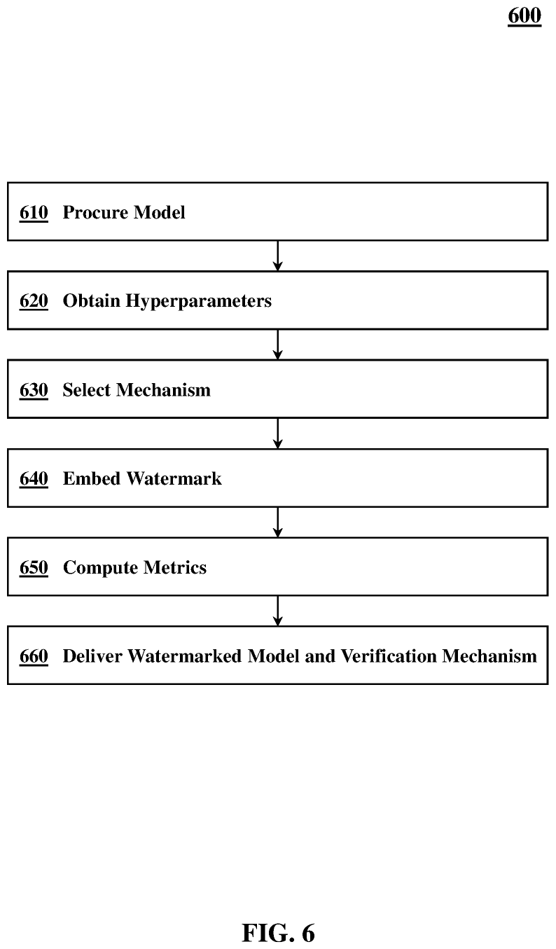

FIG. 6 illustrates a method 600 of watermarking a model in accordance with some embodiments of the present disclosure. The method 600 includes procuring 610 a model, obtaining 620 hyperparameters, selecting 630 a mechanism for embedding a watermark (e.g., based on the model and the hyperparameters), embedding 640 a watermark, computing 650 metrics (e.g., to assess model utility, watermark fidelity, and/or watermark robustness), and delivering 660 a watermarked model and verification mechanism to a user.

In some embodiments, the method 600 may be performed with a model watermarking system (e.g., model watermarking system 100 of FIG. 1). In some embodiments, the model procured may use a computation bypass mechanism (e.g., model 200 of FIG. 2), a ReX mechanism (e.g., model 300 of FIG. 3), and/or a ReD mechanism (e.g., model 400 of FIG. 4).

In some embodiments, procuring 610 a model may be receiving a fully trained model, and in some embodiments, procuring 610 a model may be receiving a partially trained model. In some embodiments, procuring 610 a model may be receiving model training information and constructing a model therewith. In some embodiments, procuring 610 the model and embedding 640 the watermark may occur simultaneously (e.g., if a model to be watermarked is trained by the model watermarking system, the training and watermarking may happen together).

A computer program product in accordance with the present disclosure may include a computer readable storage medium having program instructions embodied therewith. The program instructions may be executable by a processor to cause the processor to perform a function. The function may include procuring a model and obtaining hyperparameters for watermarking the model. The function may include embedding a watermark in the model using the hyperparameters to achieve a watermarked model and delivering the watermarked model and a watermark verification mechanism to a user.

In some embodiments of the present disclosure, the model may be a deep generative model.

In some embodiments of the present disclosure, the hyperparameters may include target metrics for model utility and watermark fidelity. In some embodiments of the present disclosure, the hyperparameters include a computational budget.

In some embodiments of the present disclosure, the function may include selecting a mechanism for embedding the watermark based on the model and the hyperparameters.

In some embodiments of the present disclosure, embedding the watermark may include training the model using an architecture specification, a training routine, and training data. In some embodiments of the present disclosure, the model may be pre-trained, and embedding the watermark may include modifying the model to embed the watermark.

In some embodiments of the present disclosure, the function may include computing a set of metrics to assess the watermarked model for model utility and watermark fidelity.

In some embodiments of the present disclosure, the function may include receiving the watermark. In some embodiments of the present disclosure, the function may include selecting the watermark. In some embodiments of the present disclosure, the function may include developing the watermark.

In some embodiments of the present disclosure, the watermark verification mechanism may include a trigger-target pair representing the watermark.

In some embodiments of the present disclosure, the watermark may include a trigger-target pair for the model.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment currently known or that which may be later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but the consumer has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software which may include operating systems and applications. The consumer does not manage or control the underlying cloud infrastructure but has control over operating systems, storage, and deployed applications, and the consumer possibly has limited control of select networking components (e.g., host firewalls).

Deployment models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and/or compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

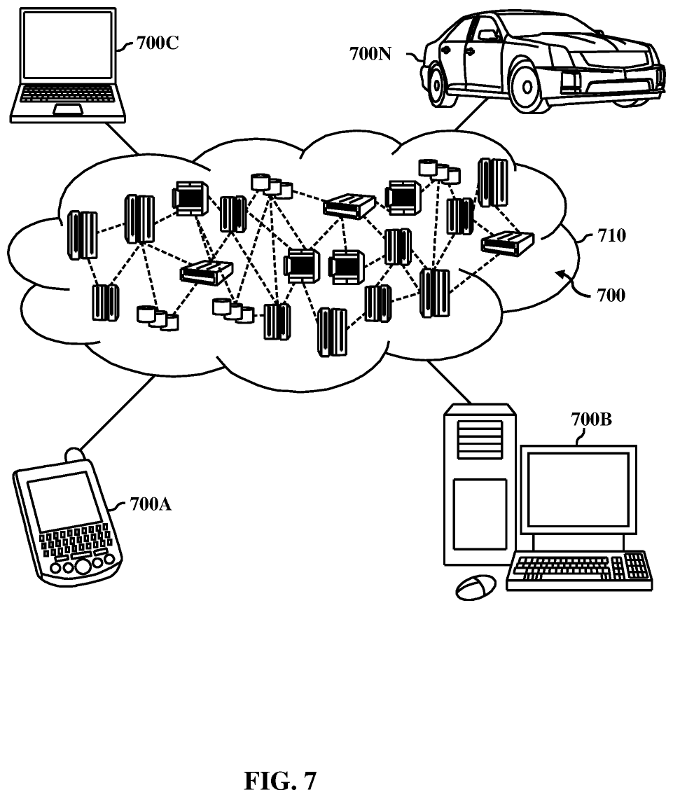

FIG. 7 illustrates a cloud computing environment 710 in accordance with embodiments of the present disclosure. As shown, cloud computing environment 710 includes one or more cloud computing nodes 700 with which local computing devices used by cloud consumers such as, for example, personal digital assistant (PDA) or cellular telephone 700A, desktop computer 700B, laptop computer 700C, and/or automobile computer system 700N may communicate. Nodes 700 may communicate with one another. They may be grouped (not shown) physically or virtually, in one or more networks, such as private, community, public, or hybrid clouds as described hereinabove, or a combination thereof.

This allows cloud computing environment 710 to offer infrastructure, platforms, and/or software as services for which a cloud consumer does not need to maintain resources on a local computing device. It is understood that the types of computing devices 700A-N shown in FIG. 7 are intended to be illustrative only and that computing nodes 700 and cloud computing environment 710 can communicate with any type of computerized device over any type of network and/or network addressable connection (e.g., using a web browser).

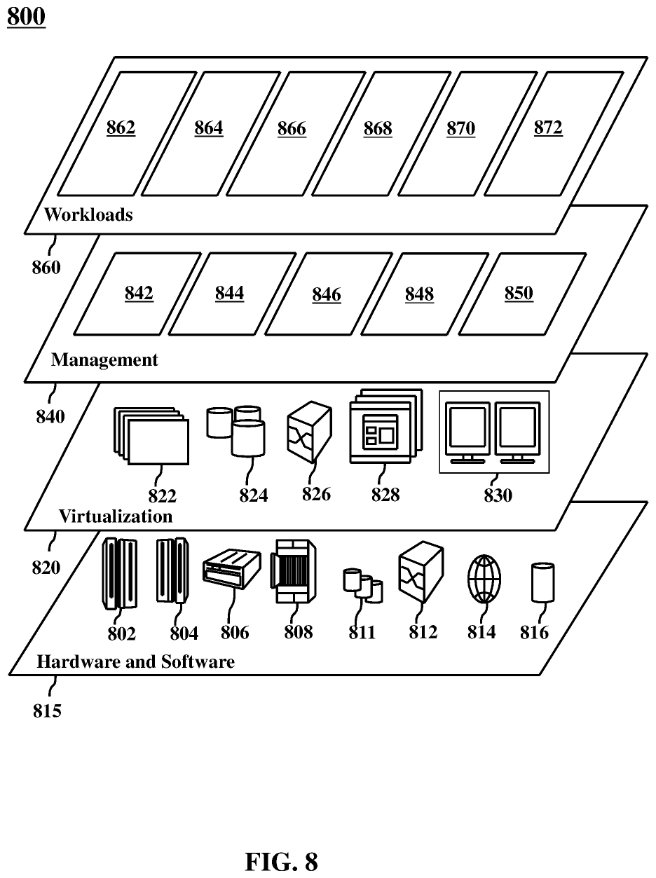

FIG. 8 illustrates abstraction model layers 800 provided by cloud computing environment 710 (FIG. 7) in accordance with embodiments of the present disclosure. It should be understood in advance that the components, layers, and functions shown in FIG. 8 are intended to be illustrative only and embodiments of the disclosure are not limited thereto. As depicted below, the following layers and corresponding functions are provided.

Hardware and software layer 815 includes hardware and software components. Examples of hardware components include: mainframes 802; RISC (Reduced Instruction Set Computer) architecture-based servers 804; servers 806; blade servers 808; storage devices 811; and networks and networking components 812. In some embodiments, software components include network application server software 814 and database software 816.

Virtualization layer 820 provides an abstraction layer from which the following examples of virtual entities may be provided: virtual servers 822; virtual storage 824; virtual networks 826, including virtual private networks; virtual applications and operating systems 828; and virtual clients 830.

In one example, management layer 840 may provide the functions described below. Resource provisioning 842 provides dynamic procurement of computing resources and other resources that are utilized to perform tasks within the cloud computing environment. Metering and pricing 844 provide cost tracking as resources and are utilized within the cloud computing environment as well as billing or invoicing for consumption of these resources. In one example, these resources may include application software licenses. Security provides identity verification for cloud consumers and tasks as well as protection for data and other resources. User portal 846 provides access to the cloud computing environment for consumers and system administrators. Service level management 848 provides cloud computing resource allocation and management such that required service levels are met. Service level agreement (SLA) planning and fulfillment 850 provide pre-arrangement for, and procurement of, cloud computing resources for which a future requirement is anticipated in accordance with an SLA.

Workloads layer 860 provides examples of functionality for which the cloud computing environment may be utilized. Examples of workloads and functions which may be provided from this layer include: mapping and navigation 862; software development and lifecycle management 864; virtual classroom education delivery 866; data analytics processing 868; transaction processing 870; and watermarking deep generative models 872.

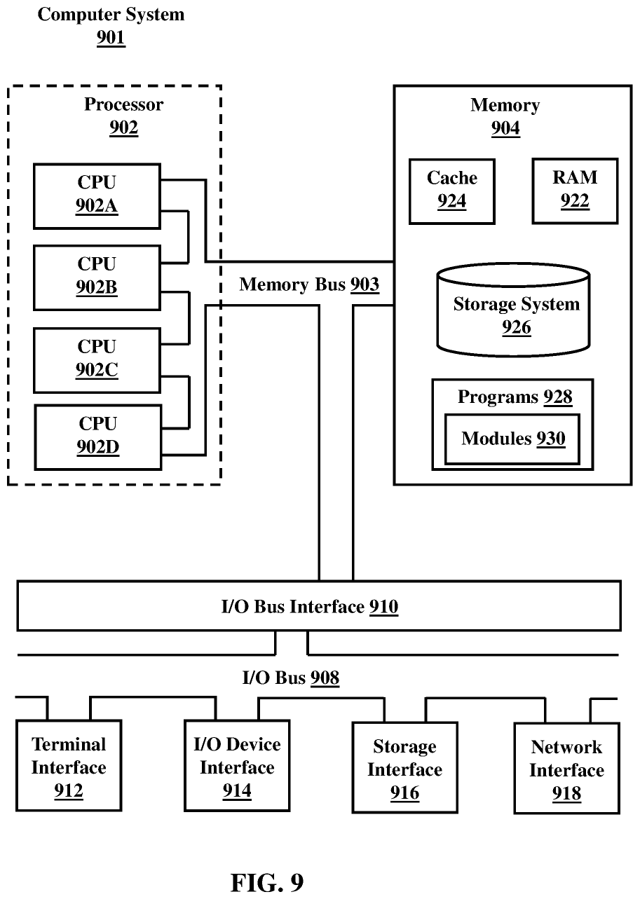

FIG. 9 illustrates a high-level block diagram of an example computer system 901 that may be used in implementing one or more of the methods, tools, and modules, and any related functions, described herein (e.g., using one or more processor circuits or computer processors of the computer) in accordance with embodiments of the present disclosure. In some embodiments, the major components of the computer system 901 may comprise a processor 902 with one or more central processing units (CPUs) 902A, 902B, 902C, and 902D, a memory subsystem 904, a terminal interface 912, a storage interface 916, an I/O (Input/Output) device interface 914, and a network interface 918, all of which may be communicatively coupled, directly or indirectly, for inter-component communication via a memory bus 903, an I/O bus 908, and an I/O bus interface unit 910.

The computer system 901 may contain one or more general-purpose programmable CPUs 902A, 902B, 902C, and 902D, herein generically referred to as the CPU 902. In some embodiments, the computer system 901 may contain multiple processors typical of a relatively large system; however, in other embodiments, the computer system 901 may alternatively be a single CPU system. Each CPU 902 may execute instructions stored in the memory subsystem 904 and may include one or more levels of on-board cache.

System memory 904 may include computer system readable media in the form of volatile memory, such as random access memory (RAM) 922 or cache memory 924. Computer system 901 may further include other removable/non-removable, volatile/non-volatile computer system storage media. By way of example only, storage system 926 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM, or other optical media can be provided. In addition, memory 904 can include flash memory, e.g., a flash memory stick drive or a flash drive. Memory devices can be connected to memory bus 903 by one or more data media interfaces. The memory 904 may include at least one program product having a set (e.g., at least one) of program modules that are configured to carry out the functions of various embodiments.

One or more programs/utilities 928, each having at least one set of program modules 930, may be stored in memory 904. The programs/utilities 928 may include a hypervisor (also referred to as a virtual machine monitor), one or more operating systems, one or more application programs, other program modules, and program data. Each of the operating systems, one or more application programs, other program modules, and program data, or some combination thereof, may include an implementation of a networking environment. Programs 928 and/or program modules 930 generally perform the functions or methodologies of various embodiments.

Although the memory bus 903 is shown in FIG. 9 as a single bus structure providing a direct communication path among the CPUs 902, the memory subsystem 904, and the I/O bus interface 910, the memory bus 903 may, in some embodiments, include multiple different buses or communication paths, which may be arranged in any of various forms, such as point-to-point links in hierarchical, star, or web configurations, multiple hierarchical buses, parallel and redundant paths, or any other appropriate type of configuration. Furthermore, while the I/O bus interface 910 and the I/O bus 908 are shown as single respective units, the computer system 901 may, in some embodiments, contain multiple I/O bus interface units 910, multiple I/O buses 908, or both. Further, while multiple I/O interface units 910 are shown, which separate the I/O bus 908 from various communications paths running to the various I/O devices, in other embodiments some or all of the I/O devices may be connected directly to one or more system I/O buses 908.

In some embodiments, the computer system 901 may be a multi-user mainframe computer system, a single-user system, a server computer, or similar device that has little or no direct user interface but receives requests from other computer systems (clients). Further, in some embodiments, the computer system 901 may be implemented as a desktop computer, portable computer, laptop or notebook computer, tablet computer, pocket computer, telephone, smartphone, network switches or routers, or any other appropriate type of electronic device.

It is noted that FIG. 9 is intended to depict the representative major components of an exemplary computer system 901. In some embodiments, however, individual components may have greater or lesser complexity than as represented in FIG. 9, components other than or in addition to those shown in FIG. 9 may be present, and the number, type, and configuration of such components may vary.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide, or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN) or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
procuring a model;
obtaining hyperparameters for watermarking said model;
embedding a watermark in said model using said hyperparameters to achieve a watermarked model; and
delivering said watermarked model and a watermark verification mechanism to a user.

2. The system of claim 1, wherein:
said model is a deep generative model.

3. The system of claim 1, wherein:
said hyperparameters include target metrics for model utility and watermark fidelity.

4. The system of claim 1, said embedding said watermark further comprising:
training said model using an architecture specification, a training routine, and training data.

5. The system of claim 1, said operations further comprising:
computing a set of metrics to assess said watermarked model for model utility and watermark fidelity.

6. The system of claim 1, said operations further comprising:
selecting a mechanism for embedding said watermark based on said model and said hyperparameters.

7. The system of claim 1, wherein:
said watermark includes a trigger-target pair for said model.

8. A computer-implemented method, said method comprising:
procuring a model;
obtaining hyperparameters for watermarking said model;
embedding a watermark in said model using said hyperparameters to achieve a watermarked model; and
delivering said watermarked model and a watermark verification mechanism to a user.

9. The method of claim 8, wherein:
said model is a deep generative model.

10. The method of claim 8, wherein:
said hyperparameters include target metrics for model utility and watermark fidelity.

11. The method of claim 8, said embedding said watermark further comprising:
training said model using an architecture specification, a training routine, and training data.

12. The method of claim 8, said embedding said watermark further comprising:
modifying said model to embed said watermark, wherein said model is pre-trained.

13. The method of claim 8, further comprising:
computing a set of metrics to assess said watermarked model for model utility and watermark fidelity.

14. The method of claim 8, further comprising:
selecting a mechanism for embedding said watermark based on said model and said hyperparameters.

15. The method of claim 8, wherein:
said watermark includes a trigger-target pair for said model.

16. A computer program product, said computer program product comprising a computer readable storage medium having program instructions embodied therewith, said program instructions executable by a processor to cause said processor to perform a function, said function comprising:
procuring a model;
obtaining hyperparameters for watermarking said model;
embedding a watermark in said model using said hyperparameters to achieve a watermarked model; and
delivering said watermarked model and a watermark verification mechanism to a user.

17. The computer program product of claim 16, wherein:
said model is a deep generative model.

18. The computer program product of claim 16, wherein:
said hyperparameters include target metrics for model utility and watermark fidelity.

19. The computer program product of claim 16, said function further comprising:
computing a set of metrics to assess said watermarked model for model utility and watermark fidelity.

20. The computer program product of claim 16, said function further comprising:
selecting a mechanism for embedding said watermark based on said model and said hyperparameters.
